(19) United States
(12) Patent Application Publication
(10) Pub. No.: US 2004/0258455 A1
(43) Pub. Date: Dec. 23, 2004

(54) Combination writing instrument and device for displaying entertainment content

(76) Inventor: Joseph Brunetti, New York, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/462,510

(22) Filed: Jun. 17, 2003

(51) Int. Cl. B43K 29/00

(52) U.S. Cl. 401/195; 401/52

(57) ABSTRACT

A combination writing instrument and entertainment device having a permanently affixed, laminated scroll contained therein, a portion of which is extendible and retractable for conveying content pertaining to entertainment or recreational purposes which is customizable by a user. The laminated scroll/sheet is provided for displaying printed content thereon, e.g., the laminated sheet may be printed with designs and/or written content in the style/form of a greeting card for the express purpose of gift-giving. The greeting card on the laminated sheet may be pre-printed for any occasion and/or be customized by the user/sender for a particular recipient to contain, e.g., unique and customized written material or scents.

### BACKGROUND

1. Technical Field

The present invention relates generally to writing instruments, and in particular, to a writing utensil having entertainment and/or information providing features.

2. Description of Related Art

There have been several attempts to develop pens having extendible and/or removable paper stored within. In general, such efforts have typically produced writing devices having paper rolled within the cylindrical cavity of the pen. Such paper may or may not be retractable within the pen cavity and is used for storing/providing information such as, e.g., calendars, lists of selected dates and corresponding holidays and advertising.

However, such extendible paper is prone to being easily damaged, especially after multiple extensions and retractions of the paper. Further, prior art utilizations of a pen having retractable/extendible paper is primarily limited to informational indicia or pre-printed content only.

The present invention overcomes the problems of the prior art by providing a combination writing instrument and device for displaying entertainment content which is durable, reusable and comprises content of entertainment and/or recreational value which further may be customizable by a user, without adversely affecting the size or writing ability of the writing instrument.

### SUMMARY OF THE INVENTION

The present invention is directed to a writing instrument having a permanently affixed, laminated scroll contained therein, a portion of which is extendible and retractable for conveying printed (written and/or pictorial) content pertaining to entertainment or recreational purposes. The laminated sheet may be customizable by the user to contain additional written content, scents, etc.

In one aspect, a combination writing instrument and device for displaying entertainment content is provided comprising an upper housing having a laminated sheet in the form of a roll (i.e., a laminated scroll) disposed therein, the laminated sheet having first and second sides, a leading edge and a fixed edge. The fixed edge is permanently affixed within the upper housing. A slot is formed in the upper housing for allowing the leading edge of the laminated sheet to be threaded out of the slot to an exterior of the upper housing. A stop strip is attached along the leading edge outside of the slot, the stop strip having at least larger dimensions than dimensions of the slot. A lower housing is removably attached to said upper housing via a connector, and the upper and lower housing further support a writing portion therein. A portion of the laminated sheet is retractably extendible through the slot and is provided to display printed entertainment content thereon which is customizable by a user.

In another aspect, a combination writing instrument and device for displaying entertainment content is provided comprising an upper housing having a laminated sheet in the form of a roll disposed therein, the laminated sheet having first and second sides, a leading edge and a fixed edge, the fixed edge being permanently affixed within the upper housing. A slot is formed in the upper housing for allowing the leading edge of the laminated sheet to be threaded out of the slot to an exterior of the upper housing. A lower housing is removably attached to said upper housing, and the upper and lower housing further support a writing portion therein. A portion of the laminated sheet is retractably extendible through the slot and is provided to display printed entertainment content thereon.

These and other aspects, features, and advantages of the present invention will be described or become apparent from the following detailed description of the preferred embodiments, which is to be read in connection with the accompanying drawings.

### BRIEF DESCRIPTION OF THE DRAWINGS

FIG. 1 is a side view of a writing instrument according to one embodiment of the present invention.

FIG. 2 is a cross sectional view taken along lines 2-2 of FIG. 1 and looking in the direction of the arrows.

FIG. 3A depicts the writing instrument of FIG. 1 having an extended scroll according to an embodiment of the present invention.

FIGS. 3B and 3C are front and back views, respectively, of a writing instrument having an extended scroll with entertainment content printed thereon.

FIG. 3D depicts an exemplary illustration of a writing instrument according to the present invention having an extended scroll comprising pre-printed and customized content printed thereon.

FIG. 4 is an exemplary illustration of a writing instrument according to the present invention in a retracted position having a transparent window for visibly displaying printed content on the retracted scroll contained therein.

### DETAILED DESCRIPTION OF PREFERRED EMBODIMENTS

Referring now to the drawings, the invention will be described in more detail. It is to be noted that while the illustrated writing instrument is an ink pen, such depictions are for exemplary purposes only and it is to be understood that the writing instrument may be that of pencil lead or other medium without departing from the scope of the present invention.

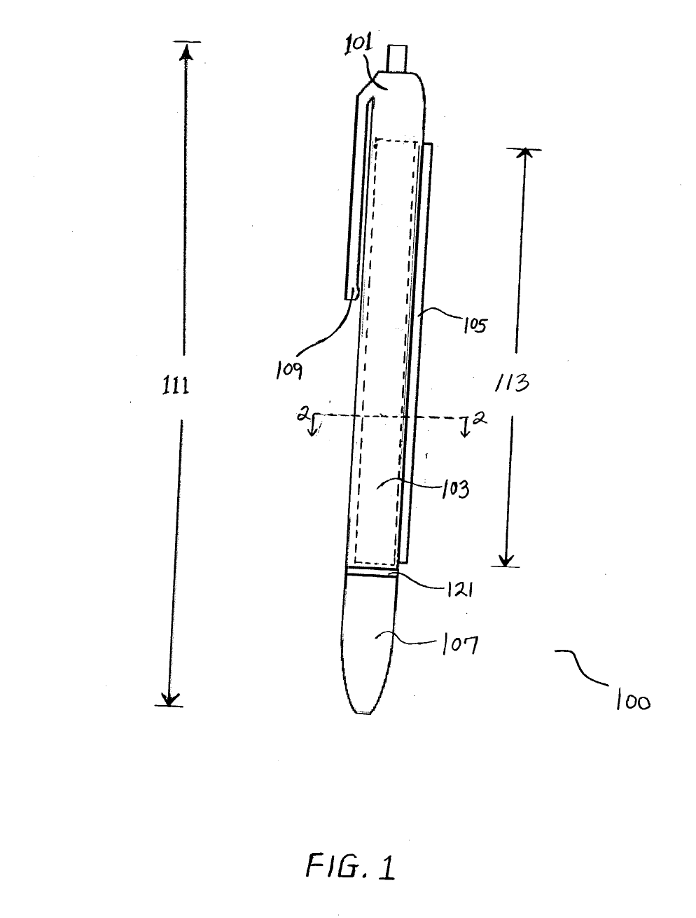

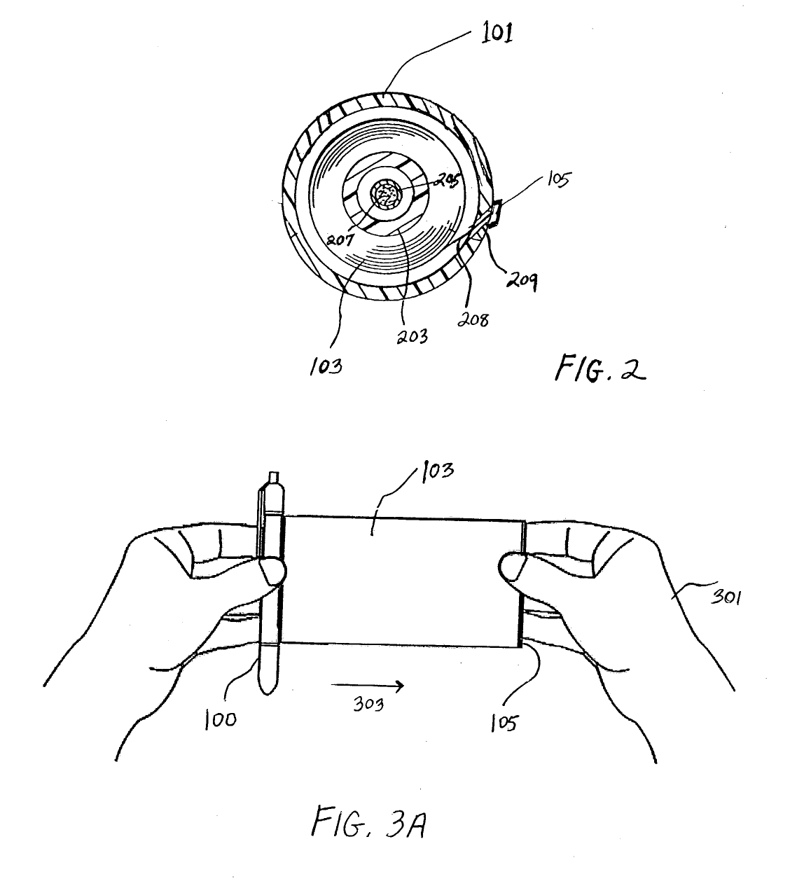

FIG. 1 denotes a writing instrument comprising an elongated upper housing 101, a lower housing 107 and a connector 121. A clip 109 attached to the upper housing 101 may also be provided. A length of laminated scroll or sheeting 103 (shown in broken lines) preferably in the form of a cylindrical roll is disposed within the upper housing 101. The laminated sheeting 103 is wound about a hollow cylindrical core 203 (see FIG. 2). A writing portion or cylindrical tube 205 is preferably disposed within a cavity of the core 203 and may comprise, e.g., ink refill 207 so that the writing instrument may be used as a pen. In other embodiments, the tube 205 may comprise lead so that the instrument could be used as a pencil, or could comprise other appropriate substances/materials so that the instrument could be used as a highlighter, marker, crayon etc.

In an exemplary embodiment, the laminated sheeting 103 may comprise, e.g., laminated paper. Alternatively, the laminated sheeting 103 may comprise any other flexible material which is capable of displaying written content thereon (e.g., it may comprise a solid sheet of plastic, vinyl, etc), or comprise wherein a laminate is applied to other writing materials besides paper). The laminated paper is preferably comprised of paper covered with a clear sheet of plastic on one side or on both sides. The laminate may be permanently affixed to the paper (e.g., as a coating) or alternatively, may comprise a plastic sheath or covering into which a sheet of paper may be removably inserted. The laminate may comprise any waterproof, flexible transparent material (e.g., vinyl, plastic, etc).

A leading edge 208 of the laminated sheeting 103 is threadable out to an exterior of the upper housing 101 through a slot 209. A portion of the leading edge 208 which is passed outside of the slot 209 includes an external stop strip 105 attached along its length (see FIG. 2). The stop strip 105 is preferably comprised of a durable rigid or semi-rigid material to facilitate gripping of the laminated sheet 103 when it is desired to be extended. Further, the stop strip 105 preferably has dimensions (e.g., a thickness and/or length) at least greater than dimensions (e.g., a thickness and/or length) of the slot 209, such that the laminated sheet 103 is prevented from being passed back through the slot 209 and thus retracted completely within the upper housing 101 when not in use.

A portion of the laminated sheet 103 is preferably extendible and automatically retractable through the slot 209 for an innumerable number of times. Such extendibility/retractability may be facilitated via any conventional extension/retraction mechanisms as known in the art. Further, the laminated sheeting 103 is preferably permanently affixed within the upper housing 101 at at least one edge or point along its length, preferably at an edge opposite to the leading edge (e.g., a fixed edge; not shown) such that the laminated sheet 103 is not fully removable/detachable from the writing instrument 100, but rather, only a portion of the laminated sheet 103 is extendible/retractable from the upper housing 101. Preferably, the fixed edge is permanently attached to the hollow core 203.

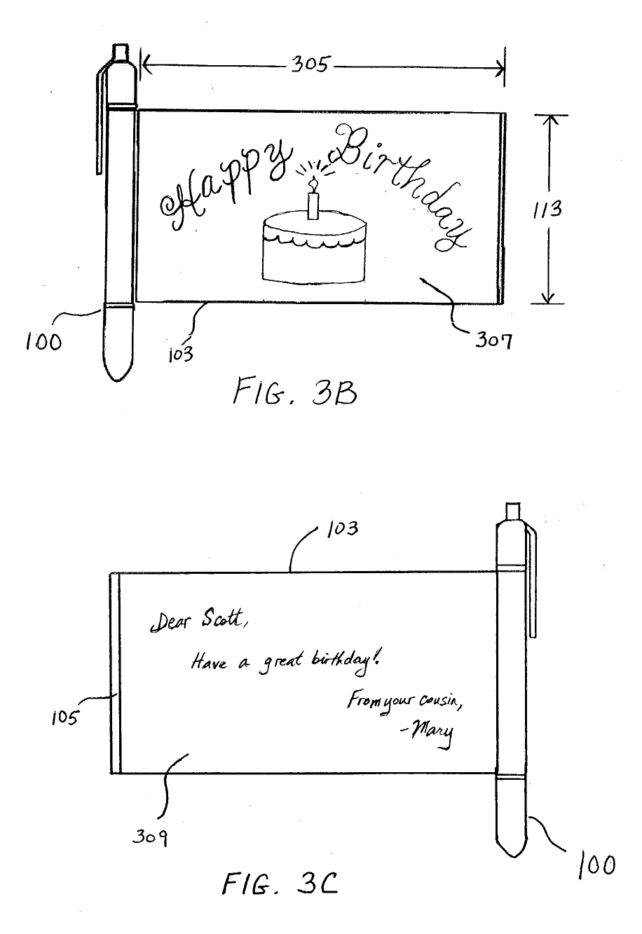

FIGS. 3A shows an extended laminated sheet 103, wherein a user 301 grasps the stop strip 105 and pulls in a direction 303 substantially away from the writing instrument 100. The user may hold the sheet 103 in its extended position manually, or the sheet 103 may have means for remaining in an extended position without a user-exerted force (e.g., via any conventional locking mechanism within said writing instrument 100), for example, as illustrated in FIGS. 3B and 3C.

In a preferred embodiment, a length 113 of the laminated sheet 103 is greater than or equal to about 50% of the total length 111 of the writing instrument 100. Even more preferably, the length 113 takes up the majority of the total length 111. In addition, a total extended width 305 of the laminated sheet 103 is preferably at least twice the dimensions of length 113. Advantageously, the unique design and construction of the writing instrument according to the present invention maximizes the size and surface area of the laminated sheet 103 and thus facilitates the display of its entertainment content in a larger, easier-to-see more attention-getting and appealing format, without adversely affecting writing ability or size of the writing instrument.

Preferably, the laminated sheet 103 is used for displaying printed content thereon having a recreational or entertainment purpose, e.g., the laminated sheet 103 may be printed with design and/or written content in the style/form of a greeting card for the express purpose of gift-giving. The greeting card on the laminated sheet 103 may be pre-printed for any occasion and/or be further rendered customizable by the user/sender for a particular recipient, to contain, e.g., unique and customized expressions, poems, letters, sayings, quotes, drawings, colors, scents and other material which is relevant, sentimental or meaningful to the recipient.

FIG. 3B shows an exemplary front view of a writing instrument 100 having a first side 307 of the laminated sheet 103 with entertainment content printed thereon, e.g., a greeting card cover. The first side 307 may be blank, may contain pre-printed content (e.g., as shown in FIG. 3B in the form of a birthday card cover), or may be written upon at least partially (e.g., contain written material) by the user/sender as described below. Preferably, the first side 307 is laminated such that the printed content of the greeting card cover on the first side 307 is protected from moisture, excessive wear, or defacement. In a non-laminated embodiment of the first side 307, the first side 307 may comprise e.g., paper or other porous writing material for providing a porous surface on which the user/sender may write upon as desired with a writing utensil, e.g., with a pen, pencil, crayon, marker, etc.

FIG. 3C shows a back view of the writing instrument of FIG. 3B. A second side 309 may or may not be laminated, and may be blank or contain pre-printed content thereon. In a non-laminated embodiment, the second side 309 may comprise, e.g., paper or other porous writing material for providing a porous surface on which a user or sender may write upon with a writing utensil, e.g., with a pen, pencil, marker, crayon, etc. Thus, the user may, for example, send a customized handwritten message (as shown in FIG. 3C). In addition, the paper or porous writing material in either of the non-laminated embodiments discussed above provides a porous surface onto which perfumes or other scents may be applied and retained thereon or include scratch-and-sniff features, etc. to further customize the greeting card.

Alternatively, if the second side 309 is laminated, it may be written upon by the user/sender by, e.g., a writing utensil which is adapted for writing on laminated surfaces (i.e., “laminated surface writing utensil”). Such writing is preferably erasable (e.g., wet or dry erasable) and can be repeated an innumerable amount of times. Advantageously, this enables a sender to further customize and freely alter, change or correct the written content on the second side 309 of the laminated sheet 103 before giving the writing instrument 100 to the recipient. It is to be noted that if both first and second sides 307 and 309 of the laminated sheet 103 are laminated, then either side may be written on by such a writing utensil in this way.

It is further to be noted that any portion of printed content on either side of the laminated sheet 103 may be pre-printed (e.g., by a manufacturer), handwritten (e.g., by a user) or a combination of both. For example, FIG. 3D shows a writing instrument 100 having an extended laminated sheet 103 comprising pre-printed content 311 (e.g., pre-printed writings and/or drawings) as well as customized content 313 (e.g., handwritten, personalized written material by the user) integrated thereon.

According to another aspect of the present invention, at least a portion of the upper housing 101 and/or the lower housing 107 may be comprised of a transparent material (e.g., clear plastic). Preferably at least the portion of the upper housing 101 covering the laminated scroll 103 (disposed within the writing instrument 100) is comprised of a transparent material so that printed content (e.g., a heading, title, theme or any information whether relevant or unrelated to the entertainment content contained therein) on the laminated scroll 103 is visibly displayed/viewable through the writing instrument 100 even though the laminated sheet 103 is in a retracted or closed position.

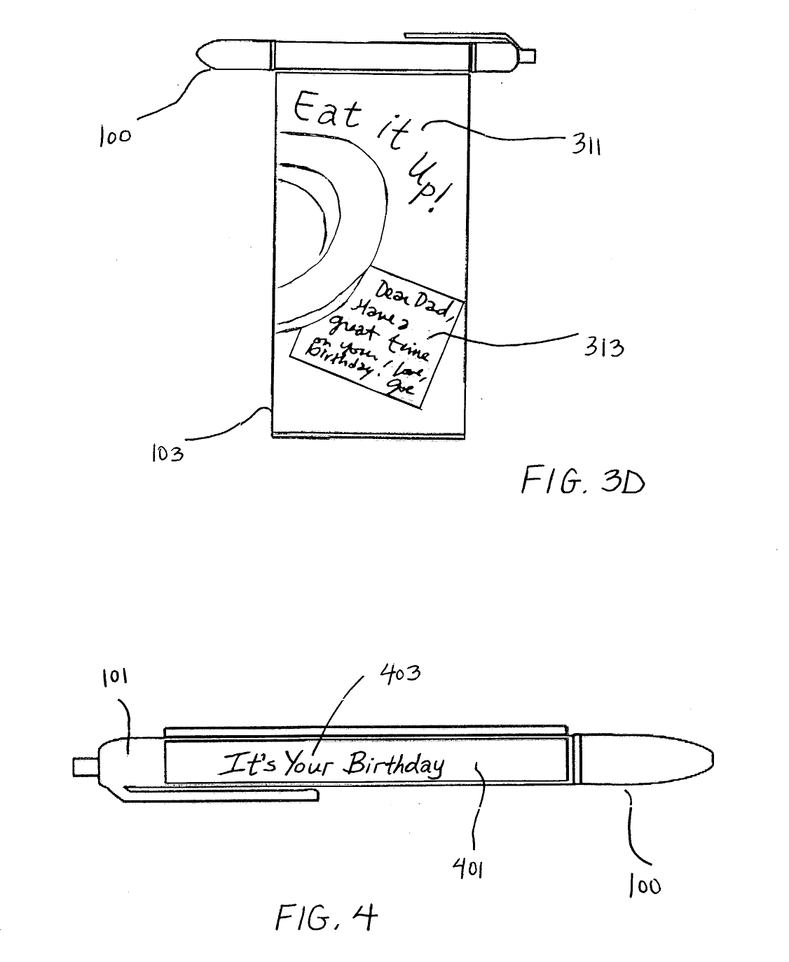

For example, FIG. 4 is an exemplary illustration of a writing instrument 100 in a closed position having a transparent window 401 for displaying a heading 403 of the entertainment content printed therein. It is to be noted that the heading 403 may include but is not limited to, for example, trivia, questions, riddles, jokes, summaries, facts, pictures, graphics, etc. It is further to be noted that the heading 403 may comprise either pre-printed or user-customized content or any combination thereof.

In an alternate embodiment, the laminated sheet 103 may be used to have printed thereon any sports team name, its official colors and logos, and information including but not limited to statistics of players, schedules of games, history, photographs, cartoons, etc. In another alternate embodiment, the laminated sheet 103 may be printed with maps including subway/bus maps (e.g., for a tourist destination), important points of interest, sketches of famous landmarks, photos, telephone numbers of major tourist sites (museums, landmarks, etc).

In other alternate embodiments, the laminated sheet 103 may have restaurant menus and contact information printed thereon, e.g., for take-out and delivery menus, or the laminated sheet 103 may be printed with the latest fashion style trends and information describing what is in or out of fashion in all style areas including but not limited to colors, fabrics, shapes, styles and accessories. Each of these alternate embodiments may further be customizable by a user to contain e.g., user-added written material and/or scents as described above.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the present invention. All such changes and modifications are intended to be included within the scope of the invention as defined by the appended claims.

What is claimed is:

1. A combination writing instrument and device for displaying entertainment content comprising:
an upper housing having a laminated sheet in the form of a roll disposed therein, the laminated sheet having first and second sides, a leading edge and a fixed edge, the fixed edge being permanently affixed within the upper housing;
a slot formed in the upper housing for allowing the leading edge of the laminated sheet to be threaded out of the slot to an exterior of the upper housing;
a stop strip attached along the leading edge outside of the slot, the stop strip having at least larger dimensions than dimensions of the slot; and
a lower housing removably attached to said upper housing via a connector, said upper and lower housing further supporting a writing portion therein; wherein a portion of the laminated sheet is retractably extendible through the slot and is provided to display printed entertainment content thereon which is customizable by a user.

2. The combination writing instrument of claim 1, wherein the laminated sheet comprises paper having at least one laminated side.

3. The combination writing instrument of claim 1, further comprising a hollow core disposed within said upper and lower housing, wherein the laminated sheet is rolled around the hollow core and said fixed edge of the laminated sheet is permanently attached to said hollow core.

4. The combination writing instrument of claim 3, wherein the writing portion is contained within the hollow core.

5. The combination writing instrument of claim 1, wherein at least one side of the laminated sheet is non-laminated for providing a porous surface to permit writing thereon via a writing utensil by the user.

6. The combination writing instrument of claim 2, wherein the at least one laminated side further comprises a writable laminated surface for allowing writing thereon via a laminated surface writing utensil by the user.

7. The combination writing instrument of claim 1, wherein the upper housing further comprises a locking mechanism for holding the laminated sheet in an extended position.

8. The combination writing instrument of claim 1, wherein at least one side of the laminated sheet is non-laminated for providing a porous surface for retaining a scent thereon.

9. The combination writing instrument of claim 1, wherein the entertainment content comprises wherein a first side of the laminated sheet displays a pre-printed greeting card cover thereon and the second side of the laminated sheet is capable of having a customized message written thereon by the user.

10. A combination writing instrument and device for displaying entertainment content comprising:
an upper housing having a laminated sheet in the form of a roll disposed therein, the laminated sheet having first and second sides, a leading edge and a fixed edge, the fixed edge being permanently affixed within the upper housing;
a slot formed in the upper housing for allowing the leading edge of the laminated sheet to be threaded out of the slot to an exterior of the upper housing; and
a lower housing removably attached to said upper housing, said upper and lower housing further supporting a writing portion therein; wherein a portion of the laminated sheet is retractably extendible through the slot and is provided to display printed entertainment content thereon.

11. The combination writing instrument of claim 10, wherein the laminated sheet comprises paper having at least one laminated side.

12. The combination writing instrument of claim 10, further comprising a hollow core disposed within said upper and lower housing, wherein the laminated sheet is rolled around the hollow core and said fixed edge of the laminated sheet is permanently attached to said hollow core.

13. The combination writing instrument of claim 12, wherein the writing portion is contained within the hollow core.

14. The combination writing instrument of claim 10, wherein at least one side of the laminated sheet is non-laminated for providing a porous surface to permit writing thereon via a writing utensil by a user.

15. The combination writing instrument of claim 11, wherein the at least one laminated side further comprises a writable laminated surface for allowing writing thereon via a laminated surface writing utensil by a user.

16. The combination writing instrument of claim 10, wherein at least one side of the laminated sheet is non-laminated for providing a porous surface for retaining a scent thereon.

17. The combination writing instrument of claim 10, wherein the entertainment content comprises wherein a first side of the laminated sheet displays a pre-printed greeting card cover thereon and the second side of the laminated sheet is capable of having a customized message written thereon by a user.

18. The combination writing instrument of claim 10, wherein the entertainment content comprises a sports team name, official colors and logos of said sports team, and information relating to said sports team.

19. The combination writing instrument of claim 10, wherein the entertainment content comprises pre-printed maps for public transportation, points of interest and landmarks, and telephone numbers of tourist sites.

20. The combination writing instrument of claim 10, wherein the entertainment content comprises a restaurant menu and contact information and contact information of said restaurant.

21. The combination writing instrument of claim 10, wherein the entertainment content comprises information on current fashion style trends.

22. The combination writing instrument of claim 10, wherein at least a portion of the upper housing is comprised of a transparent material for allowing printed content on the laminated sheet to be viewable through the upper housing when said laminated sheet is in a retracted position.
